(19) United States
(12) Patent Application Publication
(10) Pub. No.: US 2015/0104991 A1
(43) Pub. Date: Apr. 16, 2015

(54) METHOD FOR PROVIDING A LIGHT ASSEMBLY EMITTING LIGHT WITH A DESIRED COLOR TEMPERATURE AND SYSTEM FOR TESTING AND CORRECTING COLOR TEMPERATURES OF LIGHT ASSEMBLIES

(71) Applicant: LUXEXCEL HOLDING B.V., Goes (NL)

(72) Inventors: Joris Biskop, Vlissingen (NL); Richard Van De Vrie, Wolphaartsdijk (NL)

(21) Appl. No.: 14/407,308

(22) PCT Filed: Jun. 13, 2013
(86) PCT No.: PCT/EP2013/062235

§ 371 Date: Dec. 11, 2014

(30) Foreign Application Priority Data
Jun. 15, 2012 (EP) 12172171.6

(51) Int. Cl. F21K 99/00; F21V 9/08

(52) U.S. Cl. CPC F21K 9/90; F21V 9/08
USPC 445/3; 445/63

(57) ABSTRACT

The present invention refers to a method for providing a light assembly emitting light with a desired color temperature comprising the steps of providing a light source in a first step measuring the color temperature of the light source in a second step, comparing the measured color temperature with the desired color temperature in a third step and printing an optical compensation means for compensating differences between the measured color temperature and the desired color temperature in a fourth step, if the measured color temperature deviates from the desired color temperature.

### BACKGROUND

The present invention relates to a method for providing a light assembly emitting light with a desired color temperature.

In recent years, more and more conventional incandescent light bulbs have been replaced by energy saving lamps in order to achieve decreasing energy consumption and longer lifetimes of light assemblies. This was made possible, in particular, by a rapid development of LED's (light-emitting diodes) which allows a very cost-effective, energy saving and maintenance free lighting. After LED's become applicable for several applications', the focus increasingly shifted to decorative lighting using LED's. However, the quality of ambitious decorative lighting highly depends on the color temperature of the used light sources.

It is therefore disadvantageously that LED's comprises a comparatively high shift in colour temperature after manufacturing which makes the application of LED's in both decorative and functional lighting very difficult and very expensive. Today, it is distinguished between LED's with higher quality having almost the desired color temperature and LED's with lower quality whose color temperature strongly deviates from the desired color temperature. The costs for LED's with higher quality are significantly higher as the LED's with the lower quality which makes the usage of LED's in ambitious decorative lighting expensive.

### SUMMARY

It is therefore an object of the present invention to provide a method which allows a correction of the light temperature of a light source after manufacturing by way of post-processing in order to provide a light assembly emitting light with a desired color temperature.

The object of the present invention can be achieved with a method for providing a light assembly emitting light with a desired color temperature comprising the steps of providing a light source in a first step, measuring the color temperature of the light source in a second step, comparing the measured color temperature with the desired color temperature in a third step and printing an optical compensation means for compensating differences between the measured color temperature and the desired color temperature in a fourth step, if the measured color temperature deviates from the desired color temperature.

It is herewith advantageously possible to correct the color temperatures of those light sources whose color temperatures deviate from the desired color temperature because of manufacturing flaws, for instance. In particular, light sources of lower quality can be used for ambient decorative or functional lighting or other sophisticated high performance applications which requires well-defined color temperatures. Preferably, the light source comprises a light-emitting diode (LED) or an array of multiple light-emitting diodes. The method according to the present invention allows the usage of e.g. LED's of lower quality for suchlike applications. The manufacturing costs for the corresponding light assembly can therefore be reduced substantially. Furthermore, the rejection rate in the LED manufacturing process decreases because the tolerances of deviations in the color temperature can be increased.

According to a preferred embodiment of the present invention, the compensation means is printed directly or indirectly onto the light source in the fourth step, preferably the compensation means is printed in a separate first substep of the fourth step and provided onto the light source or at least near the light source in a separate second substep of the fourth step. It is e.g. conceivable that the compensation means is printed directly onto the light source or that the light source is provided with an optic and that the compensation means is printed onto the optic. It is furthermore possible that the light source is already provided with a former compensation means which does not work properly and that the new compensation means is printed onto the former compensation means in order to compensate the inaccurate working former compensation means. Preferably, the compensation means is printed as a separate optical part in a first substep of the fourth step which is provided onto the light source or at least near the light source in a second substep of the fourth step (also referred to as joining step). In the sense of the present invention, the compensation means has therefore been printed indirectly onto the light source. Alternatively, it is also conceivable to print a buffer layer onto the light source in a first substep of the fourth step and to print the compensation means onto the buffer in a second substep of the fourth step. In this embodiment, the buffer works e.g. as a thermal shield between the printed compensation means and the light source.

According to a preferred embodiment of the present invention, the color temperature is measured in the second step by switching on the light source and measuring the light emitted by the light source using a measuring unit. It is herewith advantageously possible to determine the actual color temperature in a comparatively simple way. In particular, there is no longer a need for a theoretical calculation of the color temperature which is very difficult to predict. The measuring of the color temperature is preferably performed by aid of an optical spectrometer.

Preferably, the color temperature of light emitted by the light source and transmitted by the optical compensation means is measured in a fifth step and compared with the desired color temperature in a sixth step. The fifth and sixths steps are performed in order to establish a final inspection of the actual color temperature. Preferably, a further compensation means is printed onto the compensation means if the color temperature measured in the fifth step still differs from the desired color temperature. It is herewith advantageously possible to compensate any unexpected or unpredictable deviations in the actual color temperature which arise e.g. from inaccuracies in the color of the printed optical compensation means. In this way, it is also possible to optimize the color temperature of the light source in multiple iterative steps. Preferably, the further compensation means is printed as a separate optic and provided onto the former compensation means or at least near the former compensation means or onto the light source or at least near the light source in a joining step.

According to another preferred embodiment of the present invention, the compensation means is printed in the form of a compensating layer onto the light source by depositing at least one droplet of colored printing ink by means of inkjet printing onto the light source in the fourth step. The compensation layer advantageously works as an optic which influences the color temperature of the light source in such a manner that the effective color temperature of light emitted by the light source and transmitted by the compensating layer corresponds to the desired color temperature. The use of an inkjet printing method allows a comparatively fast, cost-effective and flexible manufacturing of the compensation layer. In particular, the color of the compensation layer can be freely and very accurately selected, so that a precise adjustment of the color temperature compensation can be achieved. Preferably, the color of the colored printing ink is selected and/or mixed in dependency of the difference between the measured color temperature and the desired color temperature.

According to another preferred embodiment of the present invention, at least one light-emitting diode is provided in the first step, preferably a batch of multiple light-emitting diodes is provided in the first step, wherein the color temperature of each light-emitting diode of the batch is measured, compared and if necessary compensated individually. It is herewith advantageously possible to use a batch of LED's, wherein only those LED's of the batch whose color temperature deviates from the desired color temperature are compensated by depositing a corresponding compensation layer. It is therefore conceivable that compensation layers with different colors are located onto different LED's of the batch.

According to another preferred embodiment of the present invention, a plurality of droplets are deposited onto the light source to generate the optical compensation layer in the fourth step, wherein the individual droplets are deposited at least partially on top of each other and one beside the other. It is herewith advantageously possible to build up a light assembly with an accurate color temperature from a batch comprising an array of multiple LED's.

Another subject of the present invention is a system for testing and correcting color temperatures of light assemblies, in particular performing a method according to one of the preceding claims, wherein the system comprises a support unit for supporting a light source, a measuring unit for measuring the color temperature of the light source, an analyzing unit for comparing the measured color temperature with a desired color temperature and a printer for printing an optical compensation means for compensating differences between the measured color temperature and the desired color temperature. The system works advantageously as a test bench for testing the color temperature of light sources. Simultaneously, the systems works as a post-processing and finishing machine for compensating the color temperature of individual light sources if necessary.

Preferably, the support unit comprises a supply unit for supplying the light source with electric power; preferably the support unit supports a light source in the form of a batch of multiple light-emitting diodes. It is conceivable that the support unit comprises a universal connection means for supplying different types of light sources and LED's with electric power. The supply unit ensures that the light source can be switched on in order to measure the color temperature. The measuring means comprises e.g. an optical spectrometer. Preferably, the printer comprises a movable print head for depositing at least one droplet of printing ink directly or indirectly onto the light source building up the optical compensation means and at least one ink reservoir containing the printing ink. It is herewith advantageously possible to build up an arbitrary compensation layer having a required color for compensating the deviations in the color temperature of the light source. Furthermore, the compensation layer can be generated at an arbitrary position onto the light source and particularly onto the batch of LED's.

According to another preferred embodiment of the present invention, the printer comprises multiple ink reservoirs to store printing ink of different colors, wherein the printer is configured to mix up a printing ink of a certain color from the different colored printing ink in dependency of differences between the measured color temperature and the desired color temperature. The compensation layer has to be provided with a well-defined and individually adapted color in order to accurately compensate deviations between the actual color temperature of the light source and the desired target color temperature. This is preferably achieved by mixing several printing inks of different colors in a certain manner. This could be done in a premix chamber of the print head or at the surface where the compensation layer is built up during the printing process, for instance.

Preferably, the system comprises a transport mechanism for automatically charging and discharging the support unit with light sources.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

### BRIEF DESCRIPTION OF THE DRAWINGS

FIG. 1 illustrates schematically a method for providing a light assembly emitting light with a desired color temperature according to an exemplary embodiment of the present invention.

FIG. 2 illustrates schematically a system for testing and correcting color temperatures of light assemblies according to another exemplary embodiment of the present invention.

FIGS. 3A to 3F illustrate schematically a method for providing a light assembly emitting light with a desired color temperature performed by the system for testing and correcting color temperatures of light assemblies according to the another exemplary embodiment of the present invention.

FIG. 4 illustrates schematically a light assembly emitting light with a desired color temperature performed by the system for testing and correcting color temperatures of light assemblies according to the another exemplary embodiment of the present invention.

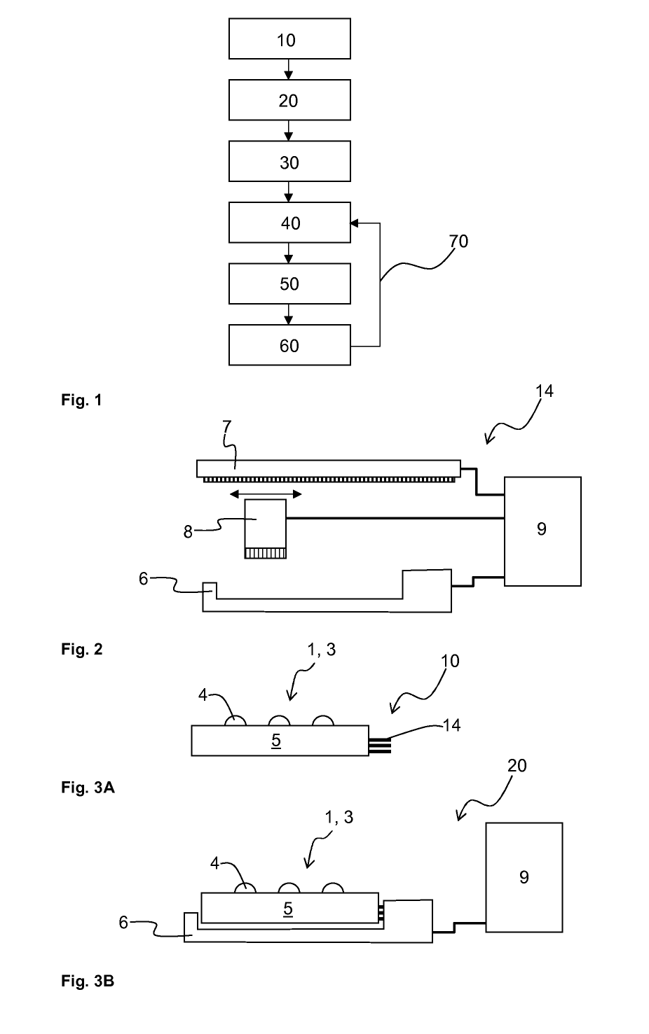

### DETAILED DESCRIPTION

The present invention will be described with respect to particular embodiments and with reference to certain drawings but the invention is not limited thereto but only by the claims. The drawings describe the invention only schematically and non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated. Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

In FIG. 1, the individual steps of a method for providing a light assembly 1 emitting light 2 with a desired color temperature according to an exemplary embodiment of the present invention are schematically shown.

In a first step 10, a light source 3 is provided. The light source 3 comprises preferably a light-emitting diode 4 (LED) or a batch comprising several light-emitting diodes 4 arranged in an even pattern. It is conceivable that the first step 10 comprises also a manufacturing step for manufacturing the light source 3.

In a second step 20, the light source 3 is turned on, so that the light source 3 emits light 2 of a certain color temperature. The color temperature of the emitted light 2 is measured by a measuring unit 7, e.g. an optical spectrometer. The color temperature is e.g. determined by analyzing the wavelength distribution of the emitted light 2.

The measured color temperature of the light source 3 is compared with a desired color temperature by an analyzing unit 9 in a third step 30. If deviations between the measured color temperature and the desired color temperature are detected, the analyzing unit 9 calculates correction values determining which colors are required to compensate the deviations in order to achieve the desired color temperature. For example, if the analyzing unit 9 detects that the color temperature of the light source 3 comprises a blue component which is too high, then the correction values determine that the blue component has to be decreased (e.g. filtering) and/or that the red component and the green component have to be increased (exemplary regarding a RGB (red-green-blue) color model).

In a fourth step 40, a printer is controlled in such a manner that a compensation means 11 in the form of a compensation layer 12 is arranged onto the light source 3. The characteristics of the compensation layer 12 are selected in such a manner that the color temperature of light 2 emitted by the light source 3 and transmitted by the compensation layer 12 is moved towards the desired color temperature. The compensation layer 12 is built up from one droplet 13 of printing ink or from multiple droplets 13 of printing ink which is/are deposited directly or indirectly onto the light source 3 by a movable print head 8 of the printer. Referring to the above example, the compensation layer 12 comprises e.g. a higher amount of red and green components, so that the blue component is relatively decreased. The printing ink preferably comprises a UV curable liquid monomer. Preferably, the droplets 13 of printing ink are polymerized by curing with an UV LED located near the print head 8 after deposition. It is conceivable that the droplets 13 are deposited one above the other and/or one beside the other in order to generate a higher layer thickness. In principle, it would also be possible to generate a compensation means with a complex surface shape, working e.g. as a lens, for implementing further optical characteristics. It is conceivable that a buffer layer working as thermal shield is printed onto the light source 3 before printing the compensation layer 12 onto the light source 3, so that the compensation layer 12 is less heated by the light source 3.

Subsequently, the light source 3 is switched on again and the color temperature of the light 2 emitted by the light source 3 and transmitted by the compensation means 11 is measured in a fifth step 50. The measured light temperature is compared to the desired light temperature again in a sixth step 60. The fifth and sixths steps 50, 60 are performed in order to establish a final inspection of the actual color temperature, before the light source 3 is delivered or further processed. If the actual color temperature still differs from the desired color temperature, a further printing procedure for printing another compensation layer 12′ onto the former compensation layer 12 is performed. The printing, measuring and comparing steps are repeated 70 iteratively until the difference between the actual color temperature and the desired color temperature falls below a certain threshold or until the difference does not decrease any more. The light source 3 and the compensation layers 12, 12′ form together the light assembly 1 in the sense of the present invention.

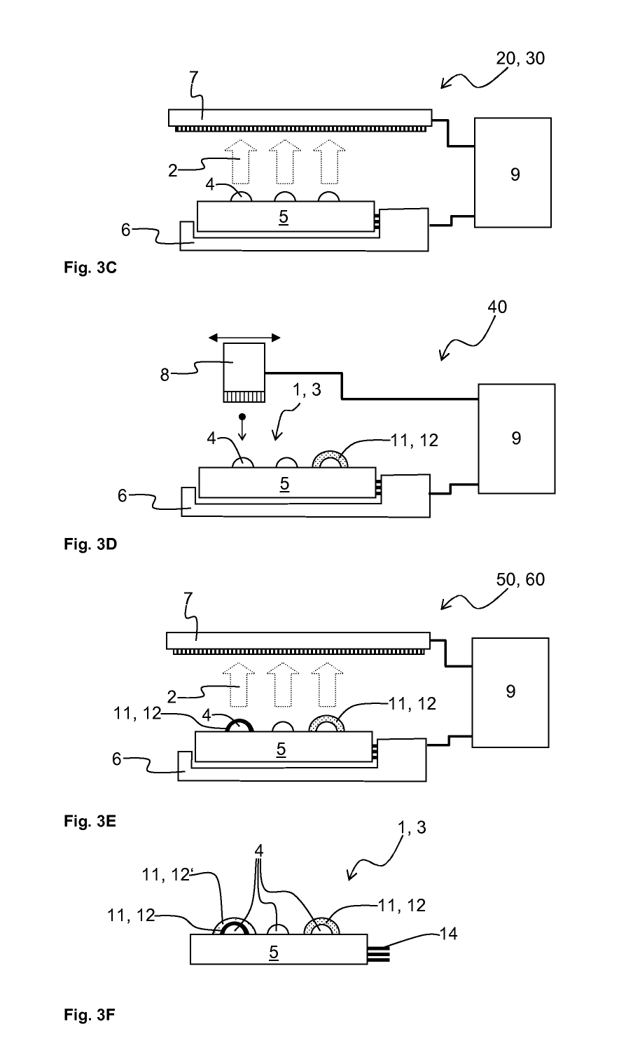

A system 14 for testing and correcting color temperatures of light assemblies 1 according to another exemplary embodiment of the present invention is shown in FIG. 3. The system 14 comprises a support unit 6 for supporting and connecting a batch of LED's 4. The system 14 further comprises a measuring unit 7 for measuring the color temperature of light 2 emitted by LED's 4 of a batch supported by the support unit 6 and a movable print head 8 for depositing droplets 13 of printing ink onto LED's 4 in order to build up compensation layers 12 onto the LED's 4, if necessary. An analyzing unit 9 receives measured color temperature data from the measuring unit 7 and compares the measured color temperature data with a preselected color temperature value (also referred to as the desired color temperature). The preselected color temperature value can be selected e.g. by a user of system 1. If the measured color temperature deviates from the preselected color temperature, the analyzing unit 9 calculates the required color and/or shape of an appropriate compensation layer 12 to at least partially compensate the detected deviation between the measured color temperature and the preselected color temperature. Subsequently, the print head 9 builds up a corresponding compensation layer 12 by depositing droplets 13 of a printing ink onto the light source 3 in such a manner that the color temperature of the light source 3 is moved towards the desired color temperature. The result can be verified by measuring again the color temperature of the light source 3 provided with the compensation layer 12 with the measuring unit 7. If the changed color temperature is still not satisfactory, another compensation layers 12′ could be deposited onto the former compensation layer 12 in subsequent iterative steps until the measured color temperature corresponds to the desired color temperature.

In FIGS. 3A to 3F, a method for providing a light assembly 1 emitting light 2 with a desired color temperature performed by the system 14 for testing and correcting color temperatures of light assemblies according to the another exemplary embodiment of the present invention is schematically shown.

FIG. 3A shows a light source 3 in the form of a batch as manufactured and provided in the first step 10. The batch comprises a substrate 5 and multiple LED's 4 provided on the substrate 5. The substrate 5 further comprises a connector 14, in particular several conductor lines made of electrically conductive metals, for supplying the LED's 4 with electrical power.

FIG. 3B shows a substep of the second step 20, in which the light source 3 is positioned in the support unit 6. The connector 14 is electrically connected to contact elements of the supply unit 6 supplying the LED's 4 with electrical power. Consequently, the LED's 4 are switched on.

In FIG. 3C, the light 2 emitted by the switched on LED's 4 are shown schematically. In a further substep of the second step 20, the light 2 is measured by the measuring unit 7. Especially, the color temperature of the light 2 emitted by the LED's 4 is measured for every individual LED 4 by the measuring unit 7 and transmitted to the analyzing unit 9. The analyzing unit 9 compares the measured color temperatures with a preselected desired color temperature. If the difference between the measured color temperature and the desired color temperature exceeds a predefined threshold for certain LED's 4, the color and/or shape of a compensation layer 12 to be printed onto these LED's 4 are calculated by the analyzing unit 9.

FIG. 3D shows a fourth step, in which the calculated compensation layer 12 is printed by a print head 8 by aid of inkjet printing onto the corresponding LED 4 whose color temperature differs from the desired color temperature. At least the color of the compensation layer 12 is generated in such a manner that the color temperature of light 2 passing from the LED 4 through the compensation layer 12 is moved towards the desired color temperature. The compensation layer 12 is built from one single droplet 13 of printing ink deposited by the print head onto the surface of the LED 4 or the compensation layer 12 is built from multiple single droplets 13 with smaller diameters which are deposited one beside the other and/or one on top the other. In this case, the deposited droplets 13 are cured by UV irradiation after melting with each other in order to form a continuous compensation layer 12.

Subsequently, the actual color temperatures of the LED's 4 are verified in fifth and sixths steps 50, 60, illustrated in FIG. 3E, in which the color temperature of each LED 4 is measured and compared to the desired color temperature again.

If the color temperatures of all LED's 4 are substantially equal and correspond to the desired color temperature, the post-processing of the batch of LED's 4 is finished, as shown in FIG. 3F, so that the batch of LED's can be used for be used for ambient decorative lighting or other sophisticated high performance applications which requires well-defined and equal color temperatures.

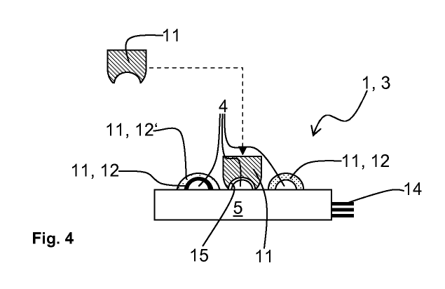

FIG. 4 illustrates schematically a light assembly emitting light with a desired color temperature performed by the system for testing and correcting color temperatures of light assemblies according to the another exemplary embodiment of the present invention. In principle, the light assembly 1 is similar to the light assembly 1 shown in FIG. 3F, but the central light source 3 is provided with a compensation means 11 which has not been printed directly onto the light source 3. Instead, the compensation means 11 has been printed in an independent fourth step (first substep of the fourth step) and provided onto the light source 3 in a subsequent joining step (second substep of the fourth step). In the sense of the present invention, the compensation means 11 has therefore been printed indirectly onto the light source 3. The compensation means 11 and the light source 3 are joined together in a form-fitted, force-fitted and/or bonded connection. Afterwards, the a fifth step 50 for measuring the color temperature of light 2 emitted by the light source 3 and transmitted by the optical compensation means 11 is performed and compared with the desired color temperature in a sixth step 60. If the color temperature does not match, another compensation means 11 could be mounted onto the previous compensation means 11 or another compensation means 11 could be printed onto the previous compensation means 11. It is conceivable that the indirectly printed compensation means 11 is also used for implementing further optical functions, like lens-effects or the like. It is conceivable that a buffer layer 15 working as thermal shield is printed onto the light source 3 before the compensation means 11 is arranged onto the light source 3, so that the printed compensation means 11 is less heated by the light source 3.

### REFERENCE SIGNS

1 light assembly
2 light
3 light source
4 light-emitting diode
5 substrate
6 support unit
7 measuring unit
8 print head
9 analyzing unit
10 first step
11 compensation means
12 compensation layer
13 droplet
14 connector
15 buffer layer
20 second step
30 third step
40 fourth step
50 fifth step
60 sixth step
70 iterative repetition

What is claimed is:

1. Method for providing a light as emitting light with a desired color temperature comprising the steps of:
Providing a light source in a first step;
Measuring the color temperature of the light source in a second step;
Comparing the measured color temperature with the desired color temperature in a third step and;
Printing an optical compensation means compensating at least partially differences between the measured color temperature and the desired color temperature in a fourth step, if the measured color temperature deviates from the desired color temperature, wherein the printing, measuring and comparing steps are repeated iteratively until the difference between the actual color temperature and the desired color temperature falls below a certain threshold or until the difference does not decrease any more, wherein the compensation means is printed directly or indirectly onto the light source in the fourth step,
wherein a buffer layer working as a thermal shield is printed onto the light source.

2. Method according to claim 1, wherein the compensation means is printed in a separate first substep of the fourth step and provided onto the light source or at least near the light source in a separate second substep of the fourth step.

3. Method according to claim 1, wherein the color temperature is measured in the second step by switching on the light source and measuring the light emitted by the light source using a measuring unit.

4. Method according to claim 4, wherein the color temperature of light emitted by the light source and transmitted by the optical compensation means is measured in a fifth step and compared with the desired color temperature in a sixth step.

5. Method according to claim 4, wherein a further compensation means is printed onto the compensation means if the color temperature measured in the fifth step still differs from the desired color temperature.

6. Method according to claim 1, wherein compensation means in the form of a compensating layer is printed onto the light source by depositing at least one droplet of colored printing ink by means of inkjet printing onto the light source in the fourth step.

7. Method according to claim 6, wherein the color of the colored printing ink is selected and/or mixed in dependency of the difference between the measured color temperature and the desired color temperature,

8. Method according to claim 1, wherein at least one light-emitting diode is provided in the first step, preferably a batch of multiple light-emitting diodes is provided in the first step, wherein the color temperature of each light-emitting diode of the batch is measured, compared and if necessary compensated individually.

9. Method according to claim 1, wherein a plurality of droplets are deposited onto the light source to generate the optical compensation layer in the fourth step, wherein the individual droplets are deposited at least partially on top of each other and one beside the other.

10. System for testing and correcting color temperatures of light assemblies, performing a method according to claim 1, wherein the system comprises:
a support unit for supporting a light source,
a measuring unit for measuring the color temperature of the light source,
an analyzing unit for comparing the measured color temperature with a desired color temperature and
a printer for printing an optical compensation means compensating at least partially differences between the measured color temperature and the desired color temperature.

11. System according to claim 10, wherein the support unit comprises a supply unit for supplying the light source with electric power, preferably the support unit supports a light source in the form of a batch of multiple light-emitting diodes.

12. System according to claim 10, wherein the measuring means comprises an optical spectrometer.

13. System according to claim 10, wherein the printer comprises a movable print head for depositing at least one droplet of printing ink directly or indirectly onto the light source building up the optical compensation means and at least one ink reservoir containing the printing ink.

14. System according to claim 13, wherein the printer comprises multiple ink reservoirs to store printing ink of different colors, wherein the printer is configured to mix up a printing ink of a certain color from the different colored printing ink in dependency of differences between the measured color temperature and the desired color temperature.

15. System according to claim 10, wherein the system comprises a transport mechanism for automatically charging and discharging the support unit with light sources.
